(19) United States
(12) Patent Application Publication
(10) Pub. No.: US 2019/0335789 A1
(43) Pub. Date: Nov. 7, 2019

(54) PACKAGED BEVERAGES, AND A PROCESS AND DEVICE FOR INTRODUCING GASES INTO PACKAGED BEVERAGES

(71) Applicants: Michael Dray, Getzville, NY (US); Nick Degenstein, The Woodlands, TX (US); John Charles Degenstein, Houston, TX (US)

(72) Inventors: Michael Dray, Getzville, NY (US); Nick Degenstein, The Woodlands, TX (US); John Charles Degenstein, Houston, TX (US)

(21) Appl. No.: 16/403,836

(22) Filed: May 6, 2019

Related U.S. Application Data
(60) Provisional application No. 62/666,832, filed on May 4, 2018.

(51) Int. Cl. A23L 2/54; B65D 85/73; B67D 1/04; B01F 3/04

(52) U.S. Cl. CPC A23L 2/54; B65D 85/73; B67D 2001/0487; B01F 3/04099; B67D 1/0406

(57) ABSTRACT

The present application is directed to a method of introducing one or more gases into a liquid that includes introducing a feed liquid into at least one vessel, injecting one or more non-CO₂ gases and, optionally, CO₂ gas into the feed liquid in the at least one vessel to obtain an effervescent liquid, filling one or more containers with the effervescent liquid, and sealing the one or more containers to obtain a packaged beverage, wherein the packaged beverage has less than 4.0 standard volume of CO₂ dissolved per volume of liquid, and wherein the packaged beverage has between 0.01 and 1 standard volume of one or more non-CO₂ gases dissolved per volume of liquid. Also, associated systems, devices, and beverages are disclosed.

### TECHNICAL FIELD

The present application relates to effervescent packaged beverages, such as beers, that contain non-CO₂ effervescent gases, inter alia. Also, the present application relates to low-cost methods and systems for delivering non-CO₂ effervescent gases and, optionally, CO₂ carbonation to beverages in containers, such as bottles and cans, to create a distinct, desirable mouth-feel and foam characteristic that enhances the consumption experience.

### BACKGROUND

The beverage industry, including producers of beer, coffee, flavored water, juices, and other liquid consumables, routinely investigates aspects that will differentiates their product in the market and/or add desirable characteristics at a lower capital or operating cost. For instance, beer producers typically produce beer that employs carbon dioxide (i.e., CO₂) for effervescence. However, beer producers may also alternatively use a mixture of nitrogen gas and CO₂ gas to effect the taste, head, pouring characteristics, mouthfeel, etc. of the product. The use of alternative mixtures of gases often requires specialized equipment for dispensing, such as the use of “nitro tap,” and for bottling and canning, such as the use of a widget that simulates dispensing from a “nitro tap” that is described in GB 1266351 and U.S. Pat. No. 4,832,968. Such specialized equipment and package increases the complexity and cost of manufacturing, which is especially difficult for small and medium craft brewers and home enthusiasts. Thus, the beverage industry desires a simple, inexpensive, and effective method, device, and apparatus to provide effervescent packaged beverages that contain non-CO₂ effervescent gases, inter alia.

Many have attempted to provide a widget-free method for packaging beer in bottles and cans due to the cost and complexity of bottling and canning with such widgets. For instance, EP 0197732 describes injecting liquid nitrogen into the top of the bottle/can just before sealing in the amount of 0.4 to 0.8 standard volume N₂ per liquid volume liquid beer or most preferably up to about 0.912 standard volume N₂ per volume liquid beer. It is clear that not all or even most of the injected liquid N₂ ended up in the fully packaged beer because that would result in a very high pressure inside the sealed can/bottle such as greater than 200 psi. However, with the amount of nitrogen that was sealed in the can, a desirable amount of N₂ foam head was observed upon pouring the beer into a glass.

More recently, U.S. Pat. No. 9,420,822 attempted to target a nitrogen-based, widget-free method for packaging beer in bottles and cans. U.S. Pat. No. 9,420,822 describes injecting nitrogen (e.g., typically liquid nitrogen) into the bottle/can just before sealing. The amount of N₂ that is in the final packaged can be estimated to be about 0.03 to 0.05 standard volumes dissolved N₂ per volume of liquid beer, based on the information provided in the “more preferred” examples. Such examples coincide with having the most N₂ dissolved in the sealed beer bottle/can, and even more dissolved N₂ gas may be desirable. Getting even this much nitrogen to dissolve into the bottle or can will be at the upper limit of the pressure that can be contained within standard bottles and can. The high pressure that dissolves this amount of N₂ (i.e., 0.03 to 0.05 v/v) is due to the lack of N₂ solubility in water-based solutions.

EP 0447103 describes the use of nitrogen dissolved into beer before packaging in the case of thin-walled flexible containers, such as aluminum cans. The purpose of such a process is to increase the internal pressure of the sealed flexible container to give the can a high enough internal pressure so it can withstand normal handling and stacking. The described method specifically aims to avoid the use of liquid nitrogen because, as stated, liquid nitrogen cannot be accurately and repeatably dosed on high speed packaging lines to achieve this purpose. GB 2203417 describes the use of argon gas to be dissolved into non-carbonated beverages prior to packaging in thin-walled flexible containers. Similar to EP 0447103, the purpose of GB 2203417 is to increase the internal pressure of the sealed flexible container to give the can enough pressure so it can withstand normal handling and stacking and also to allow the use of conventional filling practice for filling such non-carbonated liquids. EP 0447103 is specifically limited to beverages packaged in flexible containers using argon, and the described intent of both EP 0447103 and GB 2203417 is not to carbonate a beverage with a non-CO₂ gas, but rather to pressurize the headspace of the sealed container.

Furthermore, patent applications, such as WO 2000023357 and US 2002/0197364 describe the desire to package beer in bottle/cans without using a widget to achieve a “nitro” mouthfeel, taste, and appearance by using nitrous oxide together with N₂ and/or CO₂ to carbonate the packaged beverage. The use of nitrous oxide addresses the issue associated with the low solubility of N₂ because N₂O is highly soluble in water-based solutions like CO₂. However, N₂O is known to impart a taste to beverages, which may not be desirable. In addition, N₂O is not an inert gas and the use of three total gases instead of one or two is likely to add to the complexity of this process. Its use as an anesthetic may also decrease interest among a significant portion of the population.

WO 2008000271 describes using “insoluble” gases such as nitrogen cyclic hydrocarbons, krypton, propane, ethane, methane, argon, oxygen, hydrogen, neon, and helium in combination with a highly soluble gases (e.g., CO₂ or N₂O) to improve beer foam head characteristics where nitrogen is not the only insoluble gas used. WO 2008000271 describes a mechanism through which insoluble gases form smaller bubbles, and thus create a longer lasing beer foam head (i.e., comparing CO₂ and N₂O). In WO 2008000271, ranges of soluble and insoluble gases are discussed, but WO 2008000271 does not provide a method or system/device to inject these gases into existing packaging lines in ways that enable the use of standard commercial bottling equipment and processes. Further, WO 2008000271 discusses helium as being “an efficient gas for this application,” whereas other gases, such as krypton, are not mentioned apart from being present in a list of “insoluble” gases. WO 2008000271 also merely provides one bottling test run using helium, N₂O, and CO₂, and thus WO 2008000271 does not describe the pressure used to dissolve the amount of “non-soluble” gas to create the desired “nitro” effect when poured from a bottle or can. Even further, WO 2008000271 does not describe the use of the non-CO₂ effervescent agents in specific ways that enable non-CO₂ effervescent agents to be used in standard bottles and cans with the desired “nitro” effect, such that the final packaged product is compatible with pressure limitations of standard cans and bottles.

In addition to the above-discussed patent documents, some commercial beer producers have developed a method for bottling beer in glass bottles without a widget, such as LEFT HAND BREWING CO., GUINNESS, EMPIRE BREWING COMPANY, and WASATCH BEERS. However, these breweries do not publicly disclose their production methods. Nonetheless, pouring one of these commercially available bottled beers into a glass results in a “nitro” type beer foam head and a “nitro” mouth feel. Although this “nitro” method for bottling beer is only currently practiced by a few small or medium craft breweries, it would be of interest for other breweries to be able to bottle or can their beers using a similar widget-free method, especially brewers that prefer to distribute tunnel-pasteurized beverages. Furthermore, it would be advantageous if this new method could be used to package beer using existing/standard packaging equipment such that no or only minor changes to an existing bottling/canning line are necessary.

In view of the above-mentioned problems, the inventors have developed and describe in detail below a simple, inexpensive, and effective method, device, and apparatus to provide effervescent packaged beverages that contain non-CO₂ effervescent gases, and such effervescent packaged beverages themselves that contain non-CO₂ effervescent gases.

### BRIEF SUMMARY

In one aspect, the present application provides an effervescent packaged beverage comprising one or more non-CO₂ gases and, optionally, CO₂ gas, wherein the beverage has between 0.01 and 1 standard volume of the one or more non-CO₂ gases dissolved per volume of liquid.

In another aspect of the beverage, the beverage comprises one or more non-CO₂ gases and CO₂ gas, wherein the beverage has less than 4.0 standard volume of CO₂ dissolved per volume of liquid.

In another aspect of the beverage, the one or more non-CO₂ gases comprises non-CO₂ gases other than N₂ or N₂O.

In another aspect of the beverage, the beverage is beer.

In another aspect of the beverage, the one or more non-CO₂ gas comprises at least one non-CO₂ gas selected from the group consisting of Ar, Kr, Xe, and SF₆.

In a second aspect, the present application provides a method of introducing one or more gases into a liquid comprising: a) introducing a feed liquid into at least one vessel, b) injecting one or more non-CO₂ gases and, optionally, CO₂ gas into the feed liquid in the at least one vessel to obtain an effervescent liquid, c) filling one or more containers with the effervescent liquid, and d) sealing the one or more containers to obtain one or more packaged beverages, wherein the one or more packaged beverages has less than 4.0 standard volume of CO₂ dissolved per volume of liquid, and wherein the one or more packaged beverages has between 0.01 and 1 standard volume of one or more non-CO₂ gases dissolved per volume of liquid.

In another aspect of the method, the feed liquid comprises at least one of dissolved CO₂ or one or more dissolved non-CO₂ gases.

In another aspect of the method, the effervescent liquid has an amount of one or more non-CO₂ gases and, optionally, CO₂ gas that is greater than the feed liquid.

In another aspect of the method, the one or more non-CO₂ gases comprises non-CO₂ gases other than N₂ or N₂O.

In another aspect of the method, the feed liquid is beer.

In another aspect of the method, the one or more non-CO₂ gas comprises at least one non-CO₂ gas selected from the group consisting of Ar, Kr, Xe, and SF₆.

In another aspect of the method, the one or more packaged beverages has between 0.05 and 0.3 standard volumes of the one or more non-CO₂ gases dissolved per volume of liquid.

In another aspect of the method, the CO₂ and the one or more non-CO₂ gases are injected separately or together in the at least one vessel.

In another aspect of the method, CO₂, nitrogen, N₂O, or some other non-CO₂ gas is used to pressurize or maintain pressure in a headspace of the at least one vessel.

In another aspect of the method, the method comprises a step of purging the one or more containers with CO₂, nitrogen, N₂O, or some other non-CO₂ gas.

In another aspect of the method, the at least one vessel has a pressure greater than an equilibrium pressure of the packaged beverage.

In another aspect of the method, the method is a continuous process.

In another aspect of the method, the method is a batch process.

In another aspect of the method, the method comprises adding at least one of a fermentable sugar or yeast to the feed liquid.

In another aspect of the method, the feed liquid comprises at least one of a fermentable sugar or yeast.

In another aspect of the method, the one or more packaged beverages has greater than 0.5 standard volume of CO₂ per volume of liquid.

In another aspect of the method, the sealing occurs within 5 to 15 seconds of completion of the filling.

In another aspect of the method, the sealing occurs within 5 seconds of completion of the filling.

In another aspect of the method, liquid in the at least one vessel is within 5° F. of 32° F.

In another aspect of the method, equilibrium pressure of the one or more packaged beverages does not exceed a pressure rating of the one or more containers at a maximum expected storage temperature of 120° F. or at a peak post-packaging pasteurization temperature.

In another aspect of the method, the one or more packaged beverages has a pressure that does not exceed 60 psi at 80° F.

In a third aspect, the present application provides a system for producing a package beverage comprising: at least one vessel comprising at least one input stream and at least one output stream, and a packaging unit comprising at least one input stream that is fluidly connected to at least one output stream of the at least one vessel.

In another aspect of the system, the system comprises at least one intermediate unit for cooling, storage, pumping, and/or pasteurization, wherein the at least one intermediate unit comprises at least one input stream and at least one output stream, wherein at least one input stream of the intermediate unit is fluidly connected to at least one output stream of the vessel, and wherein at least one output stream of the intermediate unit is fluidly connected to at least one input stream of the packaging unit.

In another aspect of the system, the system comprises at least one post-processing unit that receives one or more packaged beverages from the packaging unit.

In another aspect of the system, the at least one input stream of the at least one vessel includes: a beer input stream; optionally, a CO₂ gas input stream; and a one or more non-CO₂ gases input stream.

In another aspect of the system, the at least one input stream of the at least one vessel includes: a beer input stream; and a CO₂ gas and a one or more non-CO₂ gases input stream.

In another aspect of the system, an additional vessel comprising at least one input stream and at least one output stream, wherein the at least one input stream of the additional vessel is fluidly connected to at least one output stream of the vessel, and wherein at least one output stream of the additional vessel is fluidly connected to at least one input stream of the packaging unit.

In another aspect of the system, the system comprises a fermentable sugar and/or yeast input stream that is fluidly connected to a beer input stream and/or directly to the at least one vessel.

In another aspect of the system, the system comprises an additional vessel comprising at least one input stream and at least one output stream, wherein a beer stream fluidly connects to an input stream of the at least one vessel and an input stream of the additional vessel, wherein the at least one vessel further includes a CO₂ input stream, wherein the additional vessel further includes a one or more non-CO₂ gases input stream, wherein an output stream from the at least one vessel and an output stream from the additional vessel combine before fluidly connecting to an input of the packaging unit.

In another aspect of the system, the system comprises a pressuring gas input stream.

In another aspect of the system, the at least one vessel is a pipe or inline mixer.

In a fourth aspect, the present application provides a device for introducing one or more gases into a packaged beverage comprising: a. means for introducing a feed liquid into at least one vessel; b. means for injecting one or more non-CO₂ gases and, optionally, CO₂ gas into the feed liquid in the at least one vessel to obtain an effervescent liquid; c. means for packaging the effervescent liquid into the one or more containers to obtain one or more packaged beverages, wherein the one or more packaged beverages has less than 4.0 standard volume of CO₂ dissolved per volume of liquid, and wherein the one or more packaged beverages has between 0.01 and 1 standard volume of one or more non-CO₂ gases dissolved per volume of liquid.

In another aspect of the device, the feed liquid comprises at least one of dissolved CO₂ or one or more dissolved non-CO₂ gases.

In another aspect of the device, the effervescent liquid has an amount of one or more non-CO₂ gases and, optionally, CO₂ gas that is greater than the feed liquid.

In another aspect of the device, the one or more non-CO₂ gases comprises non-CO₂ gases other than N₂ or N₂O.

In another aspect of the device, the feed liquid is beer.

In another aspect of the device, the one or more non-CO₂ gas comprises at least one non-CO₂ gas selected from the group consisting of Ar, Kr, Xe, and SF₆.

In another aspect of the device, the one or more packaged beverages has between 0.05 and 0.3 standard volumes of the one or more non-CO₂ gases dissolved per volume of liquid.

In another aspect of the device, the means for injecting injects the CO₂ and the one or more non-CO₂ gases separately or together in the at least one vessel.

In another aspect of the device, CO₂, nitrogen, N₂O, or some other non-CO₂ gas is used to pressurize or maintain pressure in a headspace of the at least one vessel.

In another aspect of the device, the means for packaging includes a means for purging the one or more containers with CO₂, nitrogen, N₂O, or some other non-CO₂ gas.

In another aspect of the device, the feed liquid comprises at least one of a fermentable sugar or yeast.

In another aspect of the device, the device comprises a means for adding at least one of a fermentable sugar or yeast to the feed liquid.

In another aspect of the device, the one or more packaged beverages has greater than 0.5 standard volume of CO₂ is per volume of liquid.

In another aspect of the device, the means for packaging includes a means for sealing the one or more containers within 5 to 15 seconds of completion of filling.

In another aspect of the device, the means for packaging includes a means for sealing the one or more containers within 5 seconds of completion of filling.

In another aspect of the device, liquid in the at least one vessel is within 5° F. of 32° F.

In another aspect of the device, equilibrium pressure of the one or more packaged beverages does not exceed a pressure rating of the one or more containers at a maximum expected storage temperature of 120° F. or at a peak post-packaging pasteurization temperature.

In another aspect of the device, the one or more packaged beverages has a pressure that does not exceed 60 psi at 80° F.

### BRIEF DESCRIPTION OF THE DRAWINGS

The above and other aspects, features and advantages of the present invention will be better understood when taken in connection with the accompanying Figures in which:

FIG. 1 shows the pressure and carbonation levels for bottles in various scenarios for: a) bottle/can/container conditioning and b) non-bottle/can/container conditioning (with or without pre-or post-packaging pasteurization).

FIG. 2 shows a schematic representation of a standard process for carbonating beer before packaging.

FIG. 3 shows a schematic representation of the process described in this disclosure where CO₂ and at least one non-CO₂ gas is added in a separate stream to carbonate beer before packaging.

FIG. 4 shows a schematic representation of the process described in this disclosure where CO₂ and at least one non-CO₂ gas is premixed as stream 5 and is added to beer for carbonation before packaging.

FIG. 5 shows a schematic representation of the process described in this disclosure where CO₂ gas and non-CO₂ gas are used to carbonate beer in separate vessels prior to packaging.

FIG. 6 shows a schematic representation of the process described in this disclosure where CO₂ gas and non-CO₂ gas are added to beer prior to packaging along with fermentable sugar and/or yeast for container conditioning.

FIG. 7 shows a schematic representation of the process described in this disclosure where CO₂ gas and non-CO₂ gas are used to carbonate separate streams of the feed liquid which are then re-combined prior to packaging.

FIG. 8 shows a schematic representation of the process described in this disclosure where CO₂ gas and non-CO₂ gas are used to carbonate beer prior to packaging where a vessel headspace pressurizing gas is used.

FIG. 9 shows a schematic representation of the process described in this disclosure where CO₂ gas and non-CO₂ gas are used to carbonate beer prior to packaging where the carbonation vessel is piping or tubing.

### DETAILED DESCRIPTION

The effervescent packaged beverage and the methods, devices, and apparatus related to such effervescent packaged beverage are now described by reference to the embodiments. The description provided herein is not intended to limit the scope of the claims, but to exemplify the variety encompassed by the present application. Embodiments of the claims may, however, be embodied in many different forms and should not be construed as limited to the embodiments set forth herein.

Beer, such as but not limited to ales, lagers, pilsners, stouts, and porters, is typically bottled and served using carbon dioxide (CO₂) for carbonation. Carbon dioxide is a product of fermentation, and, as such, is the natural choice for carbonation of fermented beverages, such as beer. Further, carbon dioxide is good choice for beer and other beverages for other reasons, such as: 1) carbon dioxide is safe for human consumption; 2) carbon dioxide is highly soluble in water solutions; and 3) dissolved carbon dioxide in beer contributes to the low pH of water solutions, which helps to prevent bacterial growth in finished beer or other beverages. When carbon dioxide dissolves in water, the carbon dioxide reacts with water to form carbonic acid. Carbonic acid is a weak acid that affects the pH of the water solution. The taste and “mouthfeel” that differ between otherwise similar bottled unflavored sparkling water and bottled unflavored non-sparkling (flat) water illustrates the taste and mouthfeel difference imparted by dissolved carbon dioxide to a beverage as simple as water.

Beverages, such as beer, are more complex than water, and, as such, the flavor, taste, and aroma of beer is enhanced/affected by the presence of the carbon dioxide that is dissolved in beer prior to serving and as the beer is consumed. Directly after serving beer from a pressurized beer source (e.g., bottle, can, keg, etc.), the carbon dioxide comes out of solution as bubbles forming the beer's foam “head.” As the beer continues to warm, bubbles continue to come out of solution and bubble to the top adding to the flavor and aroma of the beer being consumed.

Typically, beer is carbonated with 2.0 to 4.0 standard volumes of CO₂ per liquid volume of beer prior to serving, as described in Tasting Beer, 2nd Edition: An Insider's Guide to the World's Greatest Drink. The level of beer carbonation is determined by the temperature of the beer and the pressure of carbon dioxide in equilibrium with beer prior to packaging, bottling, and/or canning. Information on the carbonation level of beer, as determined by CO₂ pressure and beer temperature (at equilibrium conditions), is freely available in references, such as The Encyclopedia of Beer: The Beer Lover's Bible—A Complete Reference to Beer Styles, Brewing Methods, Ingredients, Festivals, Traditions, and More. Also, beer/beverages bottled with high carbonation may use thicker glass bottles, which is typical of certain beers of the “Belgian” style as well as sparkling wine (e.g., Champagne, brute, etc.).

At many bars/restaurants, most beer is served as “normal” CO₂ carbonated beer out of a regular beer tap. The beer keg supplying this tap would typically be pressurized with carbon dioxide alone. When one of these “normal” CO₂ carbonated beers is poured from the tap handle into a glass, the beer's head, flavor, and aroma are similar to the same beer poured from a bottle or can into a glass for consumption.

A draft-poured alternative to the “normal” CO₂ carbonated beer supplied from a beer keg is to dispense a “nitro” beer using a “nitro” tap (also known as a “stout” tap). Beer dispensed out of a “nitro” tap looks and tastes different from beer dispensed out of a “normal” tap. The “mouthfeel” is much creamier with less acidic taste, and the beer head is of a different consistency and is composed of much smaller bubbles. A “nitro” or “stout” tap achieves this different beer pour due to two main differences from the normal beer tap: 1) the beer in the keg is carbonated using “beer gas” or “G-gas,” which is typically a mixture of 25% carbon dioxide and 75% nitrogen; and 2) the dispensing tap hardware/device is different from a “normal” draft tap. When pressurizing beer in a keg (e.g., at a similar gauge pressure to a “normal” keg) with ¼th of the amount of carbon dioxide the carbonation level (i.e., total CO₂ dissolved in the beer) is significantly affected and is reduced by a factor of about 2.5. The reduced amount of dissolved CO₂ reduces the acidity of the beer, and thus influences the taste of the beer.

Nitrogen is much less soluble in beer and in aqueous solutions in general, as compared to carbon dioxide. In this regard, nitrogen is about 50-70 times less soluble as compared to CO₂ in water based solutions depending on temperature, as described in the CRC Handbook of Chemistry and Physics, 91st Edition, Solubility of Selected Gases in Water, L. H. Gevantman. A “nitro” or “stout” tap handle is different from a “normal” tap handle in that it contains a restrictor plate typically having many small orifices through which the beer flows just prior to the beer being dispensed into a glass. The effect/purpose of these small orifices in the restrictor plate is that, as the reduced-carbonation beer is forced through the small orifices, a “relatively” small amount of CO₂ and dissolved N₂ form small bubbles, which creates a desirably creamy, firm and long-lasting foam head. The stout tap is responsible for producing smaller bubbles than would form if the reduced carbonation beer went through a “normal” tap in which case CO₂ bubbles would nucleate and grow to a larger size. The different texture of the beer foam head is important to the different “nitro” beer taste. If the same reduced carbonation beer was dispensed through a “normal” tap, hardly any foam head would be created and the beer would look and taste flat. In summary, keg beer dispensed from a “nitro” or “stout” tap handle has a significantly different taste as compared to the same beer dispensed from a “normal” tap due to the difference in the carbonation level of the beer and reduced acidity, as well as the creamy, firm foam head that imparts a much creamier “mouthfeel” and taste. In certain bars/restaurants, two otherwise equivalent beers can be tasted side by side out of “nitro” and “normal” taps, and the taste difference for the same beer is dramatic.

Carbonation level and an appropriate beer foam head are variables that considerably affect the taste of beer, and, as such, carbonation level and beer foam head can be thought of as variables that affect the taste and mouthfeel of beer as it is consumed. This observation may also be true for other beverages, such as wine, coffee, fruit juice, flavored water, soda, etc. For this reason, beer makers (commercial or home brewers) continue to look for ways to adjust, perfect, and/or affect how beer is consumed. An example of this observation in the context of CO₂ carbonation of beer is that the “nitro” or “stout” beer tap was developed precisely so that certain styles of beer, namely “stouts,” could be consistently consumed internationally in the way that stouts were meant to be consumed by the brewers of these beverages.

As described above, the “nitro” beer tap allows beer makers to develop, brew, and serve/dispense draft beer in the way that is different from a “normal” draft beer tap. However, for bottles and cans of beer, there is significantly less flexibility for beer brewers to package and deliver their product to consumers so that the beer can be consumed in a way that is similar to “nitro” draft beer. For example, home brewers and commercial brewers alike would like to have an easy and accessible way to bottle/can their beers so that they can be consumed as a nitro beverage, similar to a draft “nitro” beer.

Globally, bottle and can packaged beer is by far the most common method of distribution so a reliable “nitro” method for packaging beer in bottles has been and continues to be of interest. For example, in the US, about 90% of total beer production is packaged in small containers (e.g., bottles and cans) as compared to beer that is packaged for draft sales (e.g., kegs and casks), as described by Briggs, Dennis E. Brewing: Science and Practice, Woodhead Publishing, 2004. Most other notable beer-producing countries package the majority of their total beer volume production in bottles and cans including: Germany 81%, China 95%, Brazil 99%, and Japan 84%. Only a few notable beer-producing countries produce the majority of their total beer volume in keg/cask form, such as Ireland, with 22% in bottles and cans.

In a widget-less bottle or can, it is difficult to achieve a “nitro” type beer foam head because it is difficult to get enough nitrogen gas to dissolve in aqueous solutions at reasonable pressures that can be contained by standard glass, plastic or aluminum bottles or by standard aluminum cans. Standard non-reusable glass bottles can reliably contain about 100 psig of pressure for at least short periods of time, but thicker glass bottles are used by some beer makers to withstand higher pressures. Standard non-reusable glass bottles are able to withstand the pressure of beer bottled with up to 3 to 4 volumes of CO₂ at up to tunnel pasteurization temperatures where the bottle is quickly heated to around 140° F. and then cooled back down to near ambient temperature, as discussed in Food Packaging: Principles and Practice, Third Edition, Gordon L. Robertson. Standard cans can contain about this same amount of pressure because canned beer is also routinely tunnel pasteurized by certain breweries, especially large breweries that desire pasteurized product to extend shelf life and reduce spoilage potential. The estimated equilibrium pressure of an aqueous solution carbonated with 3 standard volumes CO₂ per volume of liquid is 13 psig, 37 psig and ˜90 psig at 32° F., 70° F., and 120° F., respectively. The actual pressures of bottled carbonated liquids at these temperatures will vary somewhat due to the bottle/can headspace in a real packaged beverage. CO₂ solubility data at refrigerated temperatures is widely available as CO₂ carbonation charts for beer. At higher temperatures, CO₂ solubility (and that of other gases) is available in a variety of references, such as CRC Handbook of Chemistry and Physics, 91st Edition, Solubility of Selected Gases in Water, L. H. Gevantman or the NIST chemistry webbook that provides Henrys Law data for many gases in water solutions.

The inventors, while not wishing to be bound by a particular disclosure, understand that to create a desirable amount of “nitro” head and bubble cascade effect from a bottled/canned beer between 0.05 and 0.3 standard volumes of nitrogen should be dissolved per liquid volume of the packaged beverage before it is opened and poured into a glass. For the purpose of illustration and comparison, the inventors assumed that 0.1 standard volume of nitrogen gas will be enough to create a desirable amount of beer foam head upon opening a bottle or can. To dissolve this amount of nitrogen in beer, about 62 psia of N₂ gas pressure in equilibrium with the beer at a temperature of 32° F. in the bottle should be used, and thus a bottle that can contain at least 47 psig (62 psia) pressure at 32° F. and about 100 psig at 80° F. should be used. The pressure needed to contain this amount of dissolved N₂ would certainly be higher than 47 psig at 32° F. because beer would certainly contain some amount of dissolved CO₂, such as at least 1.0 standard volume CO₂ per volume beer. Although beer bottles/cans may technically be able to meet this elevated pressure, these pressures are clearly outside of what is normal for standard bottled/canned beer, and, as such, there could be more unintentional ruptures of bottles/cans during bottling/canning, pasteurization, transport, storage, and consumer handling of the packaged beverage. A standard volume of gas is commonly understood to be the volume of gas at 1 atmosphere pressure (14.7 psia) and 0° C. (i.e., 32° F.). CO₂ carbonation level in beer is commonly referred to as “volume per volume,” which means the standard volume of CO₂ dissolved per liquid volume of beverage. This “volume per volume” measure of dissolved gas will be abbreviated “v/v” and also applies to levels of non-CO₂ gas dissolved in beer or other water-based beverages.

Furthermore, bottle/can filling at about 50 psig may not be possible with most standard bottle/can filling equipment. New equipment may need to be purchased, and, even using equipment rated at higher pressure, it is expected that such a high pressure bottle filling could likely result in uncontrollable N₂ foaming following the bottle/can filling and before the bottle/can is able to be sealed.

For a widget-less nitro packaging process to be most useful to the widest range of brewers it should be compatible with: 1) standard beer processing equipment; 2) standard bottling/canning equipment; 3) standard bottles and cans; and 4) should be relatively forgiving and repeatable in terms of process conditions needed to bottle a beer having an acceptable “nitro” effect upon opening the bottle. This means that there should be no widget or liquid nitrogen required, and that the bottling line final carbonation tank (e.g., “brite tank”) and bottle/can filling pressure should not exceed normal pressures as this may require new equipment. Any extra equipment or materials or extra material costs should be minimal.

As stated above, any new widget-less nitro packaging process should be compatible with standard beer and beverage processing equipment, which includes equipment pertaining to the beverage carbonating process and equipment. As is apparent to someone skilled in the art of beer brewing and/or beverage packaging, there are a variety of methods used as a means to inject gases into beverage liquids. Carbon dioxide can be injected into batch tanks of beer or other beverages, such as fermenter vessels or brite beer tanks in the case of beer, using carbonation stones, gas sparging devices, membranes, etc. Carbonation stones or gas sparging devices are typically composed of a porous structure with small holes through which CO₂ can flow, thus creating relatively small bubbles that can be readily absorbed by the beverage liquid that is held at a pressure above ambient pressure. In the case of these carbonation stones, the gas is absorbed relatively quickly by the liquid due to the high contact area between gas and liquid as is caused by the small gas bubbles. The porous carbonation stone element could be composed of a sintered metal (e.g., stainless steel), ceramic material or any other sanitary material that is suitable for beverage contact. In small beverages batches, it is also possible to pressurize the headspace of the beverage storage tank with the carbonating gas and over time (i.e., days to weeks) the gas will naturally dissolve into the beverage liquid until the beverage liquid is saturated or near saturated with the carbonating liquid. In small beverage batches, agitation or shaking of the vessel can speed the gas absorption by the beverage by increasing the liquid and gas contact area.

Continuous beverage carbonation equipment can be used to avoid the need for carbonating batches of beer in holding or storage tanks as the beverage can be rapidly and accurately carbonated as the beverage liquid flows to the packaging equipment. Of course, there are many methods of continuous beverage carbonating equipment which is evident to someone skilled in the art of beverage carbonation and/or beverage packaging. Some of these methods involve: gas permeable membranes; gas bubble injection into a pressurized flowing beverage stream; gas bubble injection as beer flows thru a beer chilling heat exchanger; or gas bubble injection at or near a venturi (where the pressure profile thru the venturi is used help the gas bubbles quickly dissolve into the pressurized liquid). Some inline carbonation equipment is suitable for small beverage packagers (e.g., craft breweries) and some methods/equipment are suitable for large high throughput commercial breweries. Some inline carbonation equipment is advertised for CO₂ and/or nitrogen carbonation of beverages.

Many methods can be used to package beer and other beverages. Bottling has been very popular for decades, and systems exist that can bottle tens to many thousands of bottles each hour. Some basic principles apply to almost all bottling lines, such as: 1) thorough cleaning of the bottles; 2) preventing air from being in the final packaged product; and 3) keeping the beer cold during packaging. On a high-throughput line (i.e., hundreds to several thousands of bottles filled per minute), key steps include: 1) managing the bottle flow; 2) a multi-step cleaning process including soaking, pre-jetting, caustic rinse, hot water rinse, cold water rinse, and fresh water rinse; 3) filling the package; 4) final closure of the package (crowning); and 5) labeling. Filling can be done in a number of ways, such as with or without a filling tube, and a key aspect to consider in filling is ensuring little or no oxygen is in the package. Generally, this purging is done with carbon dioxide, but it is possible this can be done with nitrogen as well. In the case of bottles, sometimes vacuum purging steps can be used together with pressurized purging steps to ensure acceptably low levels of oxygen in bottle before filling. Following container purging, the bottle is typically pressurized with CO₂ and filled with beer while the container remains pressurized. As beer is filled into the bottle, the displaced gas leaves the bottle to ensure a consistent pressure inside the bottle, which is the filling step. After the bottle is fully filled, the bottle pressure is released and the fill apparatus is removed from the top of the bottle. The bottle is then transported to the capping device, but before the bottle reaches the capping device, sterilized water and/or an O₂-free gas (e.g., CO₂ or N₂) can be used to limit or eliminate oxygen from getting into the neck of the bottle before capping. Finally, the bottle is fully sealed by a capping machine.

While this disclosure envisions the use of other non-CO₂ gases besides nitrogen prior to the actual packaging step, any food-safe inert gas could be used in above mentioned purge and gas pressurizing steps, or post-fill bottle neck inerting step without a material decrease in the efficacy of the alternative non-CO₂ gas on the final beer characteristics. It is expected that the process described in this disclosure would be applicable to virtually all major bottling lines with minimal change. That is, minor and inexpensive changes to piping, valves, and, optionally, control systems to account for the different source of non-CO₂ gas and the different ratios of non-CO₂ gas in the beer pre-and-post packaging are envisaged. It is expecting all the same major packaging equipment could be utilized.

Canning has also grown in popularity in recent years. Most canning processes include the same basic steps as bottling, with the same critical goals: 1) managing the can flow; 2) a multi-step cleaning process including soaking, pre-jetting, caustic rinse, hot water rinse, cold water rinse, and fresh water rinse; 3) filling the package; and 4) final closure of the package. Some differences are the different structure of the can and bottle, and the wide opening of a can. However, the inventors understand that these differences do not change the applicability of the presence disclosure. That is, it is expected that the process identified in this disclosure would be applicable to virtually all major canning lines with minimal change, and that minor and inexpensive changes to piping, valves, and optionally control systems to account for the different source of non-CO₂ gas and the different ratios of non-CO₂ gas in the beer pre-and-post packaging. It is expecting all the same major packaging equipment could be utilized.

A deficiency of a widget-based or widget-free liquid nitrogen-based “nitro” packaging system is that extra equipment (or equipment modifications) would be needed to deliver a widget and/or liquid nitrogen into the bottle or can. Furthermore, accurate and repeatable liquid nitrogen dosing can be challenging on the large scale of a large commercial packaging operation. The capital cost of packaging equipment is typically the highest of the entire brewery operation, as described by Briggs, Dennis E. Brewing: Science and Practice, Woodhead Publishing, 2004. Thus, it is important that any “nitro” packaging method avoid or eliminate significant changes to packaging equipment, such as widgets, liquid nitrogen dosing, etc. A deficiency of a widget-free gas nitrogen-based “nitro” packaging system is that the beer containing appropriate amounts of dissolved nitrogen (such as 0.1 v/v of dissolved nitrogen) should be packaged at higher than normal pressures (such as >60 psig) to avoid foaming, and this would be a change from normal packaging operation where beer is typically filled into the package during the counter-pressure filling step at a pressure of around 15 psig. However, the methods, devices, and apparatuses described herein allow “nitro” packaged beers containing the equal 0.1 v/v of non-CO₂ gas to be packaged at a pressure of around 15 psig.

A part of the bottling or canning process that can be important is sterilization and/or pasteurization. Sterility within the entire beer packaging process is important particularly if there will be no post packaging tunnel pasteurization step. For those breweries who choose to pasteurize their bottles or cans of beer, a tunnel pasteurization process is typically employed. The fully packaged beer bottles flow thru a large chamber where the bottles and cans are heated by water spray to about 140° F. The heated bottles and can are held there for a certain amount of time, typically about 20 minutes, to ensure sterilization of the beer, and then the containers are cooled back down to near ambient temperatures by water spray. When the bottles and cans are heated to this high temperature in the tunnel pasteurization process the internal container pressure can get to around 100 psi or greater, which is roughly near the pressure limit that standard non-returnable glass bottles and aluminum cans can withstand without significant loss resulting from package rupture or deformation. A deficiency of a widget-free nitrogen liquid or gas-based “nitro” packaged beer is that if a “nitro” bottle or can containing 0.1 v/v of dissolved nitrogen gas was subjected to tunnel pasteurization the internal container pressure during 140° F. tunnel pasteurization would be higher (for example about 100 psi higher) versus standard CO₂-only carbonated beers, and this could lead to significantly more container ruptures/deformations leading to undesirable product loss. The method described in this disclosure avoids this problem by providing “nitro” packaged beers containing the equal 0.1 v/v of non-CO₂ gas to be tunnel pasteurized without exceeding pasteurization pressures of standard CO₂ packaged beer.

For those brewers who chose not to tunnel pasteurize after bottle/can sealing, sterility thru the entire beer processing and packaging line is extremely important to avoid contaminating the packaged beer micro-organisms that could cause reduced shelf life or spoilage. When flash pasteurization is employed, the packaging line must still remain as clean and sterile as possible to avoid micro-organism contamination in the packaged beverage. Flash pasteurization involves heating and cooling the beer liquid before packaging with only a short hold time (e.g., 15 to 60 seconds) at the high flash pasteurization temperature of up to about 175° F. Following flash pasteurization the beer flows to the packaging line. Flash pasteurization is appealing because it requires much less capital and operating cost versus tunnel pasteurization however it requires a more sterile packaging environment than is needed for tunnel pasteurization.

If no pasteurization is employed in the packaging process, then beer can be packaged with full carbonation or bottle/can conditioning can be employed when the beverage is packaged with some yeast and fermentable sugar to fully carbonate the beer within the sealed beverage container. If no tunnel pasteurization is performed, then the container would not be subjected to high pasteurization temperatures and it may be possible to package beer with more non-CO₂ gas inside the container. Furthermore, when bottle/can conditioning is utilized the beverage is packaged with less dissolved CO₂ and as a result the minimum required bottle/can filling pressure is reduced by, for example, about 5 psi (in the case of 0.5 v/v CO₂ from container conditioning). A deficiency of a nitrogen based “nitro” container is that 5 psi extra pressure would not make a very large impact on the maximum amount of dissolved non-CO₂ nitrogen gas (e.g., 0.10 v/v to 0.11 v/v dissolved N₂). However, in the case of the method described in this disclosure, 5 psi extra bottling pressure would increase the amount of dissolved non-CO₂ gas by up to about 30 to 70% (e.g., 0.10 v/v to 0.13 v/v or 0.17 v/v). By using the method described in this disclosure a more desirable “nitro” effect could be generated versus what is possible by using nitrogen.

Ideally, a widget-less nitro bottling or canning method should be compatible with various commonly used methods used to package, carbonate and pasteurize beer, such as those described above. Variations of common packaging/processing methods include: 1) bottling/canning with full carbonation (no bottle/can conditioning) and no post-packaging tunnel pasteurization; 2) bottling/canning with full carbonation (no bottle/can conditioning) with post packaging tunnel pasteurization; and 3) bottle/can conditioning where the beer is packaged with less than full carbonation (meaning that there can be no post (tunnel) or pre-bottling (flash) pasteurization). In all these methods, most brewers use process pressures and bottling line equipment that is operated at pressures well below those required to dissolve or keep appreciable amounts of nitrogen dissolved in the beer solution

Nitrogen gas is the common gas of choice for “helping” to create the “nitro” type draft effect as well as the gas of choice for creating the “nitro” effect using widgets in cans/bottles. Nitrogen is an ideal gas for many reasons (e.g., cost, availability, inert-ness, tasteless) in these applications, but it is deficient in at least one key way: it is a quite insoluble gas in aqueous solutions, as described above. Depending on temperature nitrogen is 50 to 70 times less soluble in aqueous solutions than CO₂. This means that nitrogen requires 50 to 70 times more pressure to reach an equal amount of dissolved gas aqueous solutions as compared to CO₂. Because nitrogen is so insoluble in aqueous solutions, it is a relatively poor candidate to use as a non-CO₂ carbonating gas for widget free bottles/can packaging of beer.

Besides nitrogen, other possible chemically inert gases include noble gases, such as helium, neon, argon, krypton and xenon. Additional alternative gases would be nitrous oxide, which is already used in medical applications, and sulfur hexafluoride. Of these gases, helium and neon are even less soluble in aqueous solutions than nitrogen. However, argon, krypton and xenon are roughly 2, 4.5, and 9 times more soluble than nitrogen, respectively, at normal beer packaging temperatures.

For nitrogen, the beer should be pressurized with about 62 psia of N₂ gas (at equilibrium) to achieve 0.1 v/v carbonation in beer. Only about 28, 14 and 7 psia of gas pressure should be used (at equilibrium) in the case of argon, krypton and xenon, respectively, to achieve the same inert gas effervescence (0.1 v/v) as 62 psia of nitrogen. “Carbonation” generally refers to dissolved CO₂ in a water-based solution, but, for the purpose of this disclosure, the inventors considered that “carbonation” can also refer to other non-CO₂ gases that are dissolved in a water-based solution, such as dissolved nitrogen gas, argon gas, krypton gas, etc. Furthermore, for the purpose of the description of this disclosure “effervescence” and “carbonation” can be considered to have the same meaning, For example, argon carbonation has the same meaning as argon effervescence, and both refer to the presence and/or the amount of gas dissolved in a liquid solution. The amount of carbonation or effervescence is typically stated as ‘volume per volume’ or ‘v/v’ which has been defined elsewhere herein.

Bottled/canned beer may need to contain a minimum of 0.8 to 1.5 volumes of CO₂ and at the time of bottling at normal bottling temperatures (32° F.), which would use 8 to 14 psia of CO₂ pressure. For example, low CO₂ carbonation could be desirable in the case of bottle/can conditioning where additional CO₂ is formed via sugar fermentation inside the bottle/can after packaging. Gas partial pressures for 0.1 v/v of argon effervescence and 0.8 to 1.5 v/v of CO₂ carbonation (i.e., “partial” pressures are additive to arrive at the total pressure) would use 21.3 psig to 28.3 psig total pressure (37-43 psia) at equilibrium. In the case of argon, these pressures can be contained in standard bottles and this bottling/canning pressure might be compatible with standard bottling and canning equipment for this example where there is bottle/can conditioning (and no post-bottling tunnel pasteurization). However, in the scenario where the beer will be tunnel pasteurized after packaging, argon filling to this level of argon carbonation could result in too much bottle pressure during the pasteurization process. In the case of krypton, xenon, N₂O and SF₆ gas, the bottling and tunnel pasteurization pressures would be reasonable for a similar non-CO₂ gas effervescence.

For 0.1 v/v of krypton and 0.8 to 1.5 v/v of CO₂, the minimum bottling pressure would be 7.3 to 13.3 psig (22 to 28 psia). For 0.1 v/v xenon and 0.8 to 1.5 v/v of CO₂, the minimum bottling pressure would be between 0.3 and 6.7 psig (15 to 21 psia). In the case of krypton and xenon, the minimum carbonation and bottling pressures are possible to achieve in normal carbonation and bottling equipment, even in the case where post bottling tunnel pasteurization is performed.

Of five candidate gases (i.e., argon, krypton, xenon, nitrous oxide, and sulfur hexafluoride) as alternative non-CO₂ carbonating gases, argon is widely available, and krypton and xenon are available in much lower volumes and at higher prices. Nitrous oxide and sulfur hexafluoride prices fall between those of argon and krypton. All of these gases are more expensive than nitrogen and carbon dioxide. Even though argon, krypton xenon, nitrous oxide and sulfur hexafluoride are all more expensive than nitrogen, the amount of the gases that would be contained in a 12-ounce beer bottle is estimated to be only about 0.05 to 0.3 times the volume of the beer (v/v) which is 0.6 to 3.6 fluid ounces of the gases at standard conditions. This is about 0.0175 to 0.106 standard liters of the gases (per 12 ounce bottle or can), which at current prices is a relatively low and economically feasible cost per bottle or can for many or all of the non-CO₂ the gases mentioned above.

Because all the candidate non-CO₂ effervescent gases described in this application are more expensive than nitrogen an efficient gas delivery and the bottling process should minimize the usage of the non-CO₂ effervescent agents (argon, krypton, xenon, N₂O and SF₆, etc.). At the time of writing, the approximate market prices indicate that CO₂ and nitrogen gas prices are approximately 0.4 cents per standard liter of gas (for individual cylinders of gas). At this CO₂ gas price, a 12 oz. beer serving contains about 0.2 cents of added CO₂ considering that the average 12 ounce beer serving contains about 1.5 v/v of added “non-natural” CO₂ (in addition to the ˜1.0 v/v CO₂ contained in beer after primary fermentation). For a “nitro” bottled beer containing 0.1 v/v nitrogen, the cost of N₂ contained in a 12 oz. beer is about 0.012 cents. Argon, krypton and xenon are all more expensive gases than N₂ and CO₂, and, at the time of writing, the price of argon was about 2 cents per standard liter and the price of krypton was about 25 cents per standard liter. Considering these higher gas prices for argon and krypton, a 12 ounce beverage containing 0.1 v/v of argon or krypton contains 0.07 and 0.9 cents of argon and krypton, respectively. At the time of writing, no reliable xenon price reference was found, but it would certainly be more expensive than krypton. Even in the case of krypton, the value of the gas in each 12 ounce bottle of beer is reasonable for the 0.1 v/v level of effervescence described above.

Due to the high relative cost of argon and krypton gases as compared to N₂ and CO₂, the carbonation and packaging process should reduce losses of these gases. For carbonation in a batch vessel (such as a brite tank, where liquid is filled into the vessel and carbonated and then emptied to the bottling line), some ways to reduce carbonation losses of the relatively expensive gases could be: 1) to carbonate the liquid in the vessel when the vessel is as full as possible to avoid possible gas loss in the headspace; 2) to avoid venting gas from the top of the vessel during or after non-CO₂ gas carbonation; 3) after full carbonation over pressurize the vessel liquid beyond the liquid's bubble point by adding a relatively in-expensive gas, such as CO₂ or nitrogen to the vessel headspace, wherein nitrogen or another even less soluble gas may be used because it is insoluble and CO₂ could over carbonate some of the liquid in the vessel depending on sitting time, liquid/gas mixing in the vessel, etc.; 4) when the contents of this vessel are transferred (for example to the bottling line) the expanding vapor headspace of the vessel should be filled with an inexpensive gas (such as N₂ or CO₂, etc.) instead of a more expensive gas such as argon or krypton; and 5) if any gas is required in the process of bottle or can filling and sealing (such as a bottle flushing/inerting before filling and/or during the container filling operation and/or as an inerting gas prior to sealing the bottles/cans) then it is understood that a relatively inexpensive gas other than argon, krypton, xenon, etc. could be used, such as N₂ or CO₂. In certain embodiments, the container containing the beverage has a headspace comprising at least one selected from the group consisting of CO₂, nitrogen, N₂O, and non-CO₂ gases. Also, in certain embodiments, the container has a headspace pressure between 0.5 to 4 bar at room temperature.

Means for carbonating beverage liquid was discussed elsewhere herein. These methods/equipment could apply to CO₂ carbonation as well as non-CO₂ gas carbonation. If carbonation occurs in more of a continuous process, such as one where a carbonating gas is added and dissolved into a flowing stream of liquid then it is expected that potential losses of the “expensive” non-CO₂ gas can be reduced. In this case, CO₂ carbonation could still occur in a traditional “brite tank” vessel in the normal way, but the non-CO₂ gas could be, for example, added or sparged into a stream of pressurized liquid leaving the “brite tank” vessel as it travels to the bottling line or to another storage tank. Because only a relatively small amount of non-CO₂ gas needs to be added to the beverage, it is possible that it can be done continuously using an inline sparger or carbonation stone, or some other continuous carbonation process/equipment. In this case the “vessel” in which the non-CO₂ gas is added could be as simple as a section of piping with inlets for liquid and non-CO₂ gas and a liquid outlet that has increased non-CO₂ gas effervescence. For this application, it is understood that the vessel or vessels in which CO₂ and non-CO₂ carbonation take place can be “brite tanks,” piping, or any other system component that contains the liquid which is to be carbonated.

### Effervescent Packaged Beverage

The present application provides an effervescent packaged beverage that contains one or more non-CO₂ gases and, optionally, CO₂ gas. The beverage has between 0.01 and 1 standard volume of the one or more non-CO₂ gases dissolved per volume of liquid. In alternative embodiments, the beverage has between 0.05 and 0.3 standard volume of the one or more non-CO₂ gases dissolved per volume of liquid, or the beverage has between 0.08 and 0.22 standard volume of the one or more non-CO₂ gases dissolved per volume of liquid. If the beverage has less than 0.01 standard volume of the one or more non-CO₂ gases dissolved per volume of liquid, the amount of the one or more non-CO₂ gases may be insufficient to create the volume and consistency of foam head desirable in a “nitro” style beer. If the beverage has more than 1 standard volume of the one or more non-CO₂ gases dissolved per volume of liquid, the amount of the one or more non-CO₂ gases may result in the packages pressure needed to contain such a volume of dissolved gas may be higher than a container can withstand.

The beverage also optionally contains CO₂ gas. The CO₂ gas can be present in the beverage in an amount less than 4.0 standard volume of CO₂ dissolved per volume of liquid. Alternatively, the CO₂ gas can be present in the beverage in an amount of less than 1.8 standard volume of CO₂ dissolved per volume of liquid, the CO₂ gas can be present in the beverage in an amount of greater than 0.6 standard volume of CO₂ dissolved per volume of liquid, or the CO₂ gas can be present in the beverage in an amount of greater than 0.5 standard volume of CO₂ dissolved per volume of liquid. Also, the CO₂ gas can present in the beverage in an amount less than 4.0 and greater than 0.5 standard volume of CO₂ dissolved per volume of liquid, less than 2.0 and greater than 0.6 standard volume of CO₂ dissolved per volume of liquid, or less than 1.8 and greater than 0.6 standard volume of CO₂ dissolved per volume of liquid. If the CO₂ gas is present in an amount greater than 4.0 standard volume of CO₂ dissolved per volume of liquid, then the beer can become over carbonated in CO₂, the foam head may not have the desired consistency, and the mouthfeel of the beer can be the same or similar to a normal CO₂ carbonated beer. If the CO₂ gas is present in an amount less than 0.5 standard volume of CO₂ dissolved per volume of liquid, then it could be necessary to remove CO₂ from the beer prior to packaging since the CO₂ contained in beer after primary fermentation would be between 0.5 and 1.2 v/v.

In certain embodiments, the one or more non-CO₂ gases can be non-CO₂ gases other than N₂ or N₂O. N₂ is much less soluble than Ar, Kr, Xe and SF₆ in water-based solutions, which can cause difficulty in getting N₂ gas into solution before sealing the beer package. N₂O is not inert, and thus can impart taste to the beverage and has anesthetic properties. Also, in certain embodiments, the one or more non-CO₂ gas are at least one non-CO₂ gas selected from the group consisting of Ar, Kr, Xe, and SF₆.

The beverage can be any beverage, including beer, coffee, tea, flavored water, juices, and other liquid consumables. The beverage can be packaged into a bottle or can without the need for a widget to introduce one or more gases. The headspace in the packaged beverage can include the above-mentioned the one or more non-CO₂ gases and CO₂. However, as discussed elsewhere in the present disclosure, the headspace can utilize an inexpensive gas, such as N₂ or CO₂, to avoid wasting an expensive gas, such as Ar, Kr, Xe and SF₆.

Further aspects of the effervescent packaged beverage will be understanded in accordance with the methods, apparatuses, and devices hereinafter described.

Method of Introducing One or More Gases into a Liquid

The present application provides a method of introducing one or more gases into a liquid. The method contains the following steps a) to d): a) introducing a feed liquid into at least one vessel, b) injecting one or more non-CO₂ gases and, optionally, CO₂ gas into the feed liquid in the at least one vessel to obtain an effervescent liquid, c) filling one or more containers with the effervescent liquid, and d) sealing the one or more containers to obtain one or more packaged beverages. The one or more packaged beverages obtained from such a method has less than 4.0 standard volume of CO₂ dissolved per volume of liquid, and between 0.01 and 1 standard volume of one or more non-CO₂ gases dissolved per volume of liquid. However, as discussed above, the one or more packaged beverages can contain between 0.05 and 0.3 standard volume of the one or more non-CO₂ gases dissolved per volume of liquid, or the beverage has between 0.08 and 0.22 standard volume of the one or more non-CO₂ gases dissolved per volume of liquid

The one or more packaged beverages can also have greater than 0.5 standard volume of CO₂ per volume of liquid and/or less than 4.0 standard volume of CO₂ dissolved per volume of liquid. Alternatively, the CO₂ gas can be present in the beverage in an amount of less than 1.8 standard volume of CO₂ dissolved per volume of liquid, the CO₂ gas can be present in the beverage in an amount of greater than 0.6 standard volume of CO₂ dissolved per volume of liquid, or the CO₂ gas can be present in the beverage in an amount of greater than 0.5 standard volume of CO₂ dissolved per volume of liquid. Also, the CO₂ gas can present in the beverage in an amount less than 4.0 and greater than 0.5 standard volume of CO₂ dissolved per volume of liquid, less than 2.0 and greater than 0.6 standard volume of CO₂ dissolved per volume of liquid, or less than 1.8 and greater than 0.6 standard volume of CO₂ dissolved per volume of liquid. Further, the at least one vessel has a pressure greater than an equilibrium pressure of the packaged beverage, discussed below. The liquid in the at least one vessel can be within 5° F. of 32° F., but can also be within 3° F. of 32° F.

With respect to a) introducing a feed liquid into at least one vessel, the feed liquid that is introduced into the vessel contains at least one of dissolved CO₂ or one or more dissolved non-CO₂ gases in certain embodiments. The one or more non-CO₂ gases can be non-CO₂ gases other than N₂ or N₂O, and further can be at least one non-CO₂ gas selected from the group consisting of Ar, Kr, Xe, and SF₆. The feed liquid can be beer or any other liquid consumable, such as coffee, tea, flavored water, juices, etc. If the feed liquid is beer, the beer can be non-effervescent in the feed stream. The method can also include a step of adding at least one of a fermentable sugar or yeast to the feed liquid such that the feed liquid comprises at least one of a fermentable sugar or yeast.

With respect to b) injecting one or more non-CO₂ gases and, optionally, CO₂ gas into the feed liquid in the at least one vessel to obtain an effervescent liquid, the effervescent liquid has an amount of one or more non-CO₂ gases and, optionally, CO₂ gas that is greater than the feed liquid. The CO₂ and the one or more non-CO₂ gases are injected separately or together in the at least one vessel. Further, CO₂, nitrogen, N₂O, and/or other non-CO₂ gases can be used to pressurize or maintain pressure in a headspace of the at least one vessel

With respect to c) filling one or more containers with the effervescent liquid, the filling can further include a step of purging the one or more containers with CO₂, nitrogen, N₂O, and/or other non-CO₂ gases prior to the filling. The one or more containers can be purged prior to filling with any appropriate gas to remove air/oxygen from the container, which helps to reduce dissolved oxygen in the final sealed container and helps to extend shelf life, improve flavor and reduce spoilage of the package product.

With respect to d) sealing the one or more containers to obtain one or more packaged beverages, the containers can be bottles or cans. In certain embodiments, the sealing occurs within 5 to 15 seconds of completion of the filling, but can also occur within 5 seconds, 2 second, or 1 second of completion of the filling. Further, the equilibrium pressure of the one or more packaged beverages does not exceed a pressure rating of the one or more containers at a maximum expected storage temperature of 120° F. or at a peak post-packaging pasteurization temperature. For instance, the one or more packaged beverages has a pressure that does not exceed 60 psi at 80° F.

The above-discussed method can be either a continuous process or a batch process.

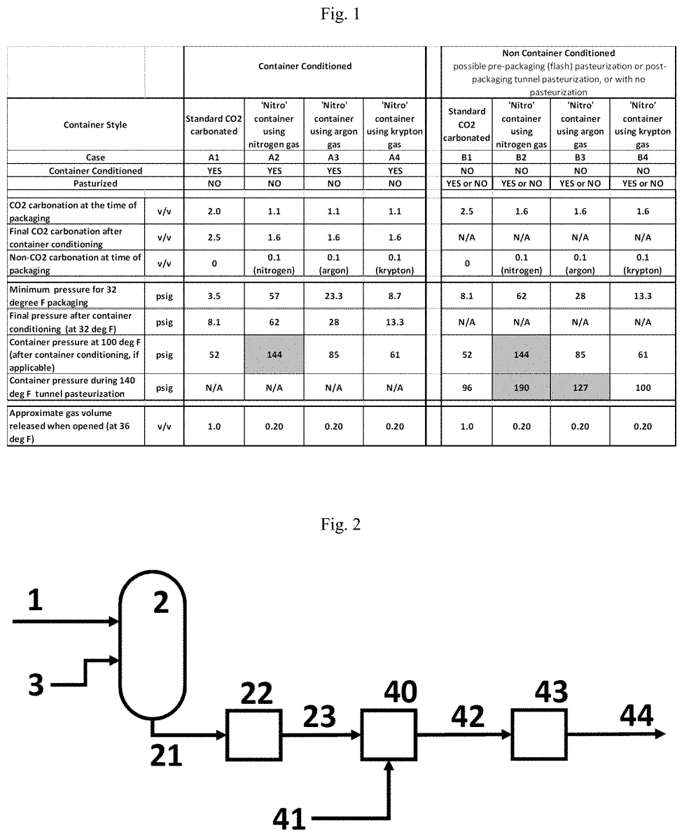

As seen in FIGS. 2 to 9, 1 is a stream or flow of beer or some other applicable beverage. In the case of beer, stream 1 has undergone primary fermentation as well as one or many other optional processes, such as filtration, cooling, pressurization, pasteurization, addition of yeast and additional fermentable sugar, addition of post-fermentation CO₂, etc. Stream 1 has a known or measurable dissolved CO₂ level in the liquid beer, for example, which can be described in terms of standard volume CO₂ dissolved per volume of liquid beer (v/v)).

Further, in FIGS. 2 to 9, 2 is one or multiple vessels into which the beer flows that includes a means for injecting a carbonating or effervescing gas into the beer, such as those discussed in detail elsewhere herein. Such vessels can be one or more traditional carbonation tanks, such as a brite (also known “bright”) tanks, or can simply be a section of piping or tubing, including piping that holds a device used to carbonate or introduce gas into beer, or a batch storage tank, etc. The vessel or vessels 2 can include carbonation stones that allow for efficient addition of CO₂ or non-CO₂ gases to the liquid contained in the vessel. Stream 3 is an optional CO₂ containing carbonating gas and stream 4 is a gas that contains at least one non-CO₂ effervescing gas, such as nitrogen, argon, krypton, xenon, N₂O, or SF₆. Stream 21 is a liquid stream potentially with increased non-CO₂ effervescence which leaves vessel 2. The stream 21 can optionally also have an increased level of CO₂ carbonation as compared to stream 1. Stream 21 travels to unit 22 which could be many processes, such as cooling, storage, pumping, pasteurization, etc. The liquid 23 then travels to the packaging line 40 where the beverage is packaged in glass bottles, plastic bottles, aluminum bottles, aluminum cans or any other suitable container. 41 denotes the flow of empty containers that are filled in the filing device 40. After the liquid is filled and sealed into the bottles/cans or some other appropriate container the packaged liquid (i.e., containing stream 42) flows to unit 43. Unit 43 comprises optional post-processing in any number of ways including post-packaging pasteurization, such as traditional tunnel pasteurization where the packaged product is heated up to about 140° F. to pasteurize the contents of the packaged product. Stream 44 represents the final product available for sale, for example directly or after container conditioning is complete.

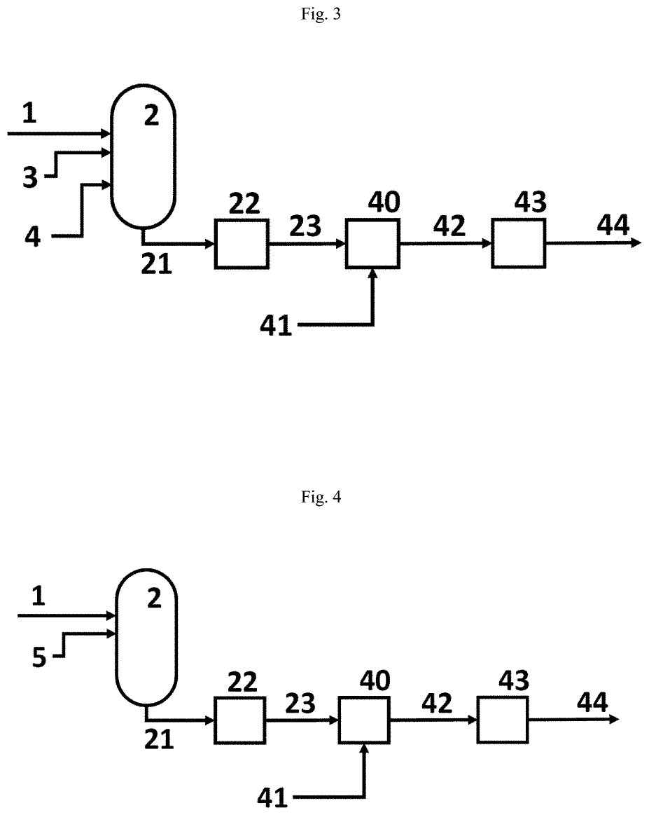

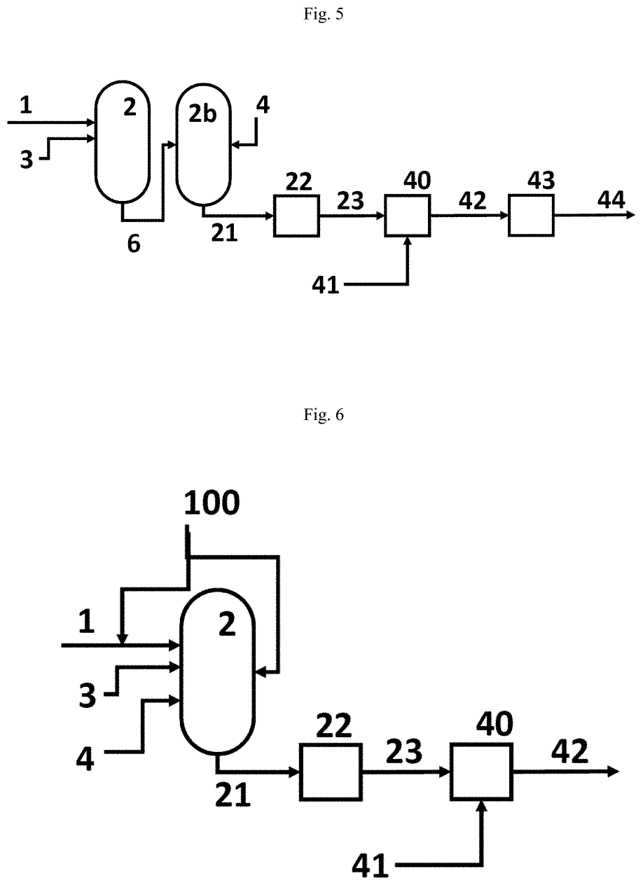

In more detail, FIG. 2 shows the existing common process for packaging normal beer carbonated only with CO₂, which is well known to those skilled in the art of brewing and beer or other beverages. FIG. 3 shows the additional non-CO₂ gas addition to unit(s) 2 as stream 4. In FIG. 3, stream 21 leaving vessel 2 has an increased level of non-CO₂ carbonation as compared to inlet stream 1. FIG. 4 shows another embodiment where the CO₂ and non-CO₂ gas are combined as stream 5 before addition to unit(s) 2. FIG. 5 specifically shows item 2 as two vessels (i.e., items 2 and 2b), where additional CO₂ is added to the first vessel as stream 3, and the non-CO₂ gas is added as stream 4 to the second vessel comprising unit 2.

FIG. 6 shows an embodiment, where the packaged beer can be bottle/can/other container conditioned. In this embodiment, fermentable sugar as well as yeast are present in the fully packaged container. Fermentable sugar and yeast (i.e., shown as item 100) can be added to the pre-packaged beer liquid in a variety of ways, such as added separately, added together, yeast was not fully removed from the primary fermentation liquid, etc. As shown in FIG. 6, the fermentable sugar and yeast are added combined with stream 1 before carbonation or are optionally added into vessel 2.

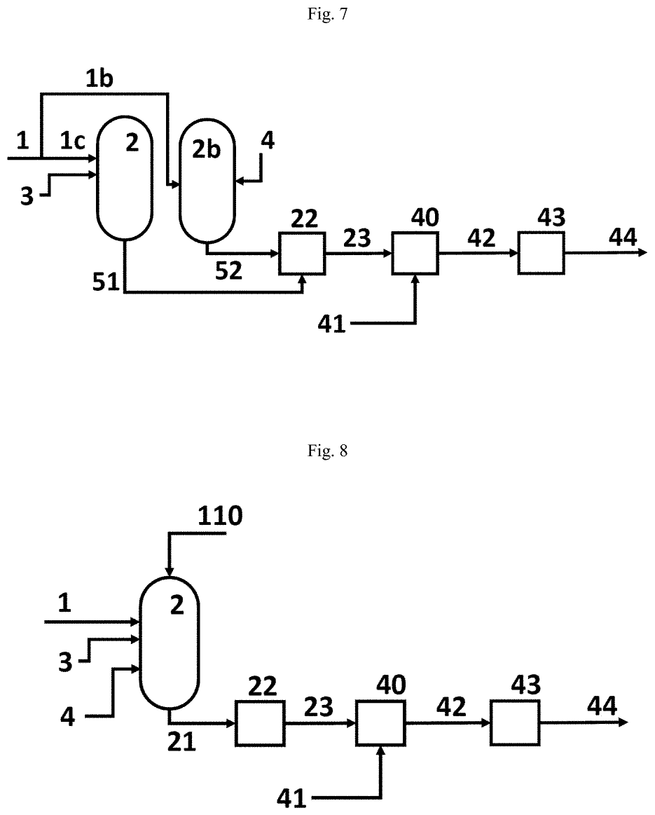

FIG. 7 shows an embodiment where the feed stream 1 is split such that part of the feed stream is sent to the first vessel 2 via steam 1c where CO₂ is added, and part of the stream 1 is sent as stream 1b to vessel 2b, where a non-CO₂ gas is added. Both streams 51 and 52, leaving vessels 2 and 2b respectively, can be combined in optional process unit 22, which could be a cooler, a turbulent mixer in a pipe, simply two lines running together, or some other process.

FIG. 8 shows an embodiment where pressuring gas 110 is used to fill the headspace of the carbonating vessel 2 or any other applicable storage tank during carbonation or as the vessel is emptied, for example when the liquid is fed to the packaging process. For example, if relatively expensive krypton gas is used as the non-CO₂ carbonating agent then it could useful fill the headspace of the storage vessel with a less expensive gas, such as nitrogen, argon, etc. Even CO₂ could be used to fill the tank headspace as the tank is emptied for packaging because there may not be much mixing action or time for this headspace CO₂ gas to carbonate the beer leaving the tank. Furthermore, the pressurizing gas 110 could be used to over-pressurize the liquid in the tank to ensure any of the dissolved gases do not come out of solution, for example during storage or liquid transfer.

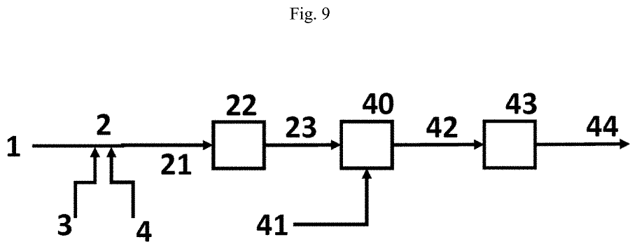

FIG. 9 shows an embodiment with no brite tank or storage vessel. A piece of continuous carbonation equipment, an inline mixer or simply a pipe connection may be used as 2, depending upon desired effect. As previously described the amount of non-CO₂ gas that needs to be dissolved is relatively small, so it may be possible to dissolve this small flow of gas using an inline mixer or carbonation stone or other continuous carbonation equipment as the beer travels to a storage tank or to the packaging line, as shown in FIG. 9.

### System for Producing a Packaged Beverage

The present application provides a system for producing a package beverage containing: at least one vessel having at least one input stream and at least one output stream, and a packaging unit containing at least one input stream that is fluidly connected to at least one output stream of the at least one vessel. The system can also contain at least one intermediate unit for cooling, storage, pumping, and/or pasteurization. The at least one intermediate unit can contain at least one input stream and at least one output stream, at least one input stream of the intermediate unit is fluidly connected to at least one output stream of the vessel, and at least one output stream of the intermediate unit is fluidly connected to at least one input stream of the packaging unit. Further, the system can contain at least one post-processing unit that receives one or more packaged beverages from the packaging unit.

In certain embodiments, the at least one input stream of the at least one vessel includes: a beer input stream; optionally, a CO₂ gas input stream; and a one or more non-CO₂ gases input stream. In additional embodiments, the at least one input stream of the at least one vessel includes: a beer input stream; and a CO₂ gas and a one or more non-CO₂ gases input stream. The system can also contain an additional vessel comprising at least one input stream and at least one output stream, wherein the at least one input stream of the additional vessel is fluidly connected to at least one output stream of the vessel, and at least one output stream of the additional vessel is fluidly connected to at least one input stream of the packaging unit.

In certain embodiments, the system can contain a fermentable sugar and/or yeast input stream that is fluidly connected to a beer input stream and/or directly to the at least one vessel. Further, in additional embodiments, the system can contain an additional vessel comprising at least one input stream and at least one output stream, wherein a beer stream fluidly connects to an input stream of the at least one vessel and an input stream of the additional vessel, wherein the at least one vessel further includes a CO₂ input stream, wherein the additional vessel further includes a one or more non-CO₂ gases input stream, wherein an output stream from the at least one vessel and an output stream from the additional vessel combine before fluidly connecting to an input of the packaging unit. The system can also contain a pressuring gas input stream. Further, the at least one vessel can be a pipe or inline mixer.

The above-described FIGS. 2 to 9 are also relevant to the system of the present application, but have not been reproduced herewith. Nonetheless, each of the above-described FIGS. 2 to 9 is applicable to the present system.

Device for Introducing One or More Gases into a Packaged Beverage

The present application provides a device for introducing one or more gases into a packaged beverage. The device can contain: a. means for introducing a feed liquid into at least one vessel; b. means for injecting one or more non-CO₂ gases and, optionally, CO₂ gas into the feed liquid in the at least one vessel to obtain an effervescent liquid; c. means for packaging the effervescent liquid into the one or more containers to obtain one or more packaged beverages. The one or more packaged beverages can have less than 4.0 standard volume of CO2 dissolved per volume of liquid, and can have between 0.01 and 1 standard volume of one or more non-CO₂ gases dissolved per volume of liquid. However, as discussed above, the one or more packaged beverages can contain between 0.05 and 0.3 standard volume of the one or more non-CO₂ gases dissolved per volume of liquid, or the beverage has between 0.08 and 0.22 standard volume of the one or more non-CO₂ gases dissolved per volume of liquid. The CO₂ gas can be present in the beverage in an amount of less than 1.8 standard volume of CO₂ dissolved per volume of liquid, the CO₂ gas can be present in the beverage in an amount of greater than 0.6 standard volume of CO₂ dissolved per volume of liquid, or the CO₂ gas can be present in the beverage in an amount of greater than 0.5 standard volume of CO₂ dissolved per volume of liquid. Also, the CO₂ gas can present in the beverage in an amount less than 4.0 and greater than 0.5 standard volume of CO₂ dissolved per volume of liquid, less than 2.0 and greater than 0.6 standard volume of CO₂ dissolved per volume of liquid, or less than 1.8 and greater than 0.6 standard volume of CO₂ dissolved per volume of liquid. The one or more non-CO₂ gas comprises at least one non-CO₂ gas selected from the group consisting of Ar, Kr, Xe, and SF₆.

In certain embodiments, the feed liquid can contain at least one of dissolved CO₂ or one or more dissolved non-CO₂ gases. The effervescent liquid has an amount of one or more non-CO₂ gases and, optionally, CO₂ gas that is greater than the feed liquid. The one or more non-CO₂ gases comprises non-CO₂ gases other than N₂ or N₂O. The feed liquid can be beer, but can also be other non-beer beverages described herein.

As discussed herein, a variety of ways to inject gases into beverage liquids exists. The present disclosure provides that the means for injecting injects the CO₂ and the one or more non-CO₂ gases separately or together in the at least one vessel. Further, CO₂, nitrogen, N₂O, or some other non-CO₂ gas can be used to pressurize or maintain pressure in a headspace of the at least one vessel. The means for packaging includes a means for purging the one or more containers with CO₂, nitrogen, N₂O, or some other non-CO₂ gas. The ways to purge the one or more containers is discussed herein.

Further, the feed liquid can contain at least one of a fermentable sugar or yeast. In certain embodiments, the device can include a means for adding at least one of a fermentable sugar or yeast to the feed liquid.

The means for packaging includes a means for sealing the one or more containers within 15 seconds of completion of filling. The means for packaging includes a means for sealing the one or more containers within 5 seconds of completion of filling. The means for packaging includes a means for sealing the one or more containers within 1 second of completion of filling.

The liquid in the at least one vessel can be within 5° F. of 32° F., and can also be within 3° F. of 32° F.

The equilibrium pressure of the one or more packaged beverages does not exceed a pressure rating of the one or more containers at a maximum expected storage temperature of 120° F. or at a peak post-packaging pasteurization temperature. The one or more packaged beverages has a pressure that does not exceed 60 psi at 80° F.

The above-described FIGS. 2 to 9 are also relevant to the device of the present application, but have not been reproduced herewith. Nonetheless, each of the above-described FIGS. 2 to 9 is applicable to the present device.

### EXAMPLES

Objects and advantages of this disclosure are further illustrated by the following examples, but the particular materials and amounts thereof recited in these examples, as well as other conditions and details, should not be construed to unduly limit this disclosure.

FIG. 1 shows a variety of illustrative example cases that compare packaging, fermentation and storage pressures of packaged beer when CO₂ versus when a CO₂ and another non-CO₂ gas is used to carbonate/effervesce the beer. When CO₂ alone is used to carbonate the beverage (i.e., Cases A1 and B1), the result is a standard container (bottle/can/other package) of beer having a normal CO₂-carbonated effect. When CO₂ and another non-CO₂ gas is used to carbonate/effervesce the beverage, the desired effect is a “nitro” type pour and mouthfeel (i.e., Cases A2 to A4 and B2 to B4). Two sets of scenarios are presented to compare normally bottled beer and “nitro” bottled beer where: a) the packaged beverage is container (i.e., bottle/can/other package) conditioned such that some of the final CO₂ carbonation is formed in the bottle/can after packaging through fermentation in the container (i.e., cases A1 to A4); and b) where the beverage is packaged with the full level of carbonation (i.e., no bottle/can conditioning) such that pre-packaging or post-packaging pasteurization could be optionally used (i.e., cases B1-B4).

In all the “nitro” scenarios shown in FIG. 1 (i.e., Cases A2 to A4 and B2 to B4), the inventors assumed that desirable to dissolve about 0.1 standard volume (0.1 v/v) of the non-CO₂ gas per volume of liquid beer. This level is kept constant for nitrogen, argon, and krypton cases to illustrate difference in internal container (i.e., bottle/can/other package) pressures at a several points: just after packaging, after complete package conditioning, during tunnel pasteurization, and for “warm” container storage (e.g., at 100° F.). This level of dissolved non-CO₂ gas is for illustration purposes and it may be desirable to dissolve less or more non-CO₂ gas depending on many factors such as: the volume of foam head desired, the desired longevity of the foam head, the consistency or mouthfeel of the foam head, the intensity and appearance of the “nitro” bubbles upon pouring the beverage, the desired method of pouring the container contents into a glass, the container temperature or range of temperatures at which the desired “nitro” effect will be observed, etc.

Depending upon the desired effect, one practicing may want to dissolve between 0.01 standard volume to 1 standard volume of non-CO₂ gas per volume of liquid beer (0.01<v/v<1). However, it may be also useful to provide 0.05 to 0.3 standard volume of gas per volume of liquid beer (0.05<v/v<0.3). Further, in all the “nitro” scenarios shown in FIG. 1, the inventors assumed that 1.6 volumes CO₂ per volume beer is the final level of CO₂ dissolved in the fully conditioned packaged beer before opening. This level of dissolved CO₂ gas per volume of liquid beer is for illustration purposes and it may be desirable to dissolve less or more CO₂ gas depending on many factors such as those described previously as well as to affect the “acidic” taste of the beverage, etc. As previously described, the presence or absence of dissolved CO₂ has an effect on the taste and mouthfeel of the beverages and also it can have an effect in highlighting or de-emphasizing various desirable or non-desirable beer flavors.

In the “nitro” cases (i.e., A2 to A4 and B2 to B4), once the sealed beverage is opened and agitated (e.g., poured into a glass or shaken and then poured into a glass), the relatively in-soluble non-CO₂ gas (i.e., nitrogen, argon or krypton) will start to come out of solution forming relatively small bubbles. These small bubbles will increase in number or will grow as additional CO₂ and non-CO₂ gas comes out of solution. However, the bubbles will not grow as large as those from a traditional CO₂-only carbonated beverage. The small bubbles will then rise to the surface of the beverage forming the beer's foam head. In these “nitro” cases, typically both CO₂ and non-CO₂ gas comes out of solution as bubbles that form the beer's “nitro” type of foam head when the bottle or can is poured into a glass. The absolute and relative amounts of CO₂ and non-CO₂ gas that come out of solution upon opening a packaged beer can be adjusted to get the desired taste, head and appearance at an acceptable non-CO₂ gas cost per packaged beverage. For example, rather than 1.6 v/v CO₂ and 0.1 v/v krypton, it may be determined that an acceptable “nitro” effect, taste and cost per bottle/can cost for a particular beer or other beverage can be achieved using 1.7 v/v CO₂ and 0.05 v/v krypton. Alternatively, 1.3 v/v CO₂ and 0.2 v/v krypton may lead to a more “optimum” balance of “nitro” effect, taste and cost per bottle/can for a different beer or beverage. The balancing of “nitro” effect, taste, and cost will depend on many factors and could be specific to the beer, brewery, equipment, or pour style.

In the CO₂-only carbonated cases (i.e., Cases A1 and B1), the inventors assumed that the final CO₂ carbonation level (i.e., after bottle/can conditioning if applicable) is 2.5 volumes CO₂ per volume of liquid beverage (2.5 v/v of CO₂). In the case of container conditioning (i.e., Cases A1 to A4), the inventors assumed that container conditioning is used to add about 0.5 volume CO₂ per volume of liquid beverage to the CO₂ dissolved in liquid beer at the time of packaging, but the carbonation added during container conditioning could be more or less. Container conditioning is done by adding a controlled amount of fermentable sugar as well some active yeast to the beer liquid prior to packaging. The active yeast converts the added fermentable sugar into alcohol and CO₂ gas that is used to fully carbonate the beverage during container storage. It will be evident to someone skilled in the art of beer making that there are many possible variations to container conditioning that can be performed in conjunction with the invention described herein.

Package conditioning can be advantageous in creating a “nitro” effect because it can be used to reduce the minimum beer bottling/canning pressure (of the bottle/can filler on the filling line). The impact of package conditioning on the minimum filling pressure is about 5 psi for each 0.5 volume/volume of CO₂ carbonation attributable to bottle/can conditioning (e.g., compare Case A1 to B1). Non-CO₂ gases, such as nitrogen, argon and krypton, all are less soluble than CO₂, and, as such, it could be difficult to get enough of these gases to dissolve into the beer given an existing bottling/canning line with a fixed maximum allowable filling pressure. Container conditioning can give about 5 psi more margin for filling the bottles/cans/other container with the maximum possible level of non-CO₂ gas, as described above.

FIG. 1 shows the expected packaging pressures at the time of packaging, fully conditioned package pressures (if applicable), warm bottle pressures (e.g., at 100° F.), and tunnel pasteurization pressures (if applicable). Cases are shown for standard CO₂ carbonated beer (i.e., Cases A1 and B1) as well as for beer having non-CO₂ dissolved gas to cause a “nitro” effect and mouthfeel upon pouring and/or consuming the beverage (i.e., Cases A2 to A4 and B2 to B4). To illustrate the benefit of using different non-CO₂ gases, FIG. 1 shows the above-mentioned pressures when nitrogen, argon and krypton gases are used as the non-CO₂ dissolved gas.

In the container conditioned cases (i.e., A1 to A4), N₂, argon and krypton have a minimum packaging pressure of 57, 23.3 and 8.7 psi respectively in the bottle/can/container filling apparatus based upon the assumption is that packaging takes place at 32° F.). Here, “minimum” refers to the saturation pressure of the beer liquid, below which gas bubbles could begin to come out of the liquid solution, thus releasing the beverage carbonation during the filling operation. For comparison, Case A1 only has a minimum packaging pressure of 3.5 psig at 32° F. to bottle beer having 2.0 v/v CO₂. A packaging pressure of 57 psi in Case A2 for the nitrogen carbonated beverage is likely too high for standard packaging lines. In the case of argon, 23.3 psi may be possible in to fill in standard packaging lines, and, in the case of krypton, a minimum packaging pressure of 8.7 psig can certainly be achieved in a standard packaging line.

FIG. 1 also shows the estimated container pressure after container conditioning is complete as well as the estimated container internal pressure if the container was heated to 100° F., for example if the fully conditioned beer container was stored in a “warm” location. In the case of nitrogen carbonation, 144 psi container pressure if the container is stored in a 100° F. environment would likely result in container ruptures or deformation which is undesirable. This internal container pressure at 100° F. assumes very little container head space, and so, in reality, the pressure may be slightly lower than the pressures depicted in FIG. 1. For container conditioned beer, tunnel pasteurization is not an option because pasteurization would kill the yeast needed for container conditioning, and so the sealed containers in cases A1 to A4 would not need to withstand tunnel pasteurization at 140° F. or more. For all “nitro” container cases, the approximate gas volume released upon opening a beer beverage at 36° F. would be approximately 0.2 v/v of gas (i.e., about half CO₂ and half non-CO₂ gas in the “nitro cases” A2, A3, A4, B2, B3 and B4). As the opened container or poured beverage continued to warm and come to equilibrium additional CO₂ and non-CO₂ gas would continue to effervesce from the beer and would serve to continuously add to the beer head from the initial pour.

In the non-container conditioned cases (Cases B1-B4) the beverage should be packaged with the full amount of CO₂ and non-CO₂ carbonation as described above resulting in about 5 psig additional minimum bottling pressure (i.e., at 32° F.). Because the final carbonation is the same as in Cases A1-A4 the 100° F. “warm” container pressure is the same. In cases B1 -B4 if post-bottling pasteurization is performed the containers would be heated up to roughly 140° F. (or more) and cooled back down. In the case of the nitrogen container (Case B2) the interior container pressure could be as high as 190 psig which is likely too high for standard (non-reusable) glass bottles or cans (again this number is slightly conservative because the assumption here is that the container/bottle/can has no or very little headspace). In the case of argon (Case B3) the internal container pressure during pasteurization is likely still too high at 127 psig but in the case of the krypton bottle (Case B4) interior container pressure during pasteurization of 100 psig is very similar to that of the CO₂ only carbonated container (Case B1) which is estimated at 96 psig. It is understood that between bottling and canning and other possible containers the maximum internal pressures and maximum allowable container temperatures may be different.

With respect to FIG. 1, Cases A4 and B4 in particular illustrate that krypton gas can be used as a non-CO₂ carbonation gas to allow a beer packaging line to 1) stay within typical operational pressures of the packaging equipment versus standard CO₂ bottling/canning and 2) to stay within pressure limits of the containers (e.g., glass bottles and aluminum cans) themselves (especially in the case where post-packaging pasteurization, such as tunnel pasteurization is performed). In the case of packaging with argon, Cases A3 and B3 illustrate that for 0.1 v/v non-CO₂ carbonation it may be possible to use argon to create a “nitro” type effect in bottles/cans, but in the case of “warm” bottles and, in the case of post-bottling pasteurization, the internal containers could be higher than typical for standard CO₂-carbonated bottles/cans. In the case of packing with dissolved nitrogen, Cases A2 and B2, the filling pressure as well as the sealed beverage container pressures at above ambient temperatures especially are likely too high for standard packaging lines as well as standard beverage containers.

The description of FIG. 1 above focuses on beer as the beverage. However, the “nitro” effect would be possible and could be a desirable effect for beverages besides beer, such as wine, cider, other alcoholic beverages, coffee, fruit juice, soft drinks, bottled water, or any other similar bottled, canned or otherwise packaged beverage. The description herein focuses on a beverage filling method that is compatible with standard non-reusable glass bottles and aluminum cans, but it is understood that the process can also be applied to plastic bottles, aluminum bottles, or any other similar and appropriate beverage container that is capable of or used to contain carbonated liquids. This could include multi-serving beverage containers where it is desirable to fill and/or contain a “nitro” style beverage at the pressures described in FIG. 1 for later dispensing and/or consumption. The description in FIG. 1 shows examples where the non-CO₂ effervescent gas is a single component gas (nitrogen, argon or krypton), but it is understood that multiple gases could be mixed and used as the non-CO₂ effervescent gas. For example, a mix of argon and krypton could be used to reduce non-CO₂ gas cost per package while still maintaining the “nitro” effect and while staying within pressure limitations of the beer processing equipment and the sealed beverage containers themselves. It is understood that other gases besides argon and krypton could be alternatives such as Xe, N₂O (which has a similarly high water solubility to CO₂), SF₆ and a range of other gases such as hydrocarbons and other food-safe aerosol propellants.

In the foregoing description, the effervescent packaged beverage and the methods, devices, and apparatus related to such effervescent packaged beverage have been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification, unless the context requires otherwise, the word “comprise” and its variations, such as “comprises” and “comprising,” will be understood to imply the inclusion of a stated item, element or step or group of items, elements or steps, but not the exclusion of any other item, element or step or group of items, elements or steps. Furthermore, the indefinite article “a” or “an” is meant to indicate one or more of the item, element or step modified by the article.

1. An effervescent packaged beverage comprising one or more non-CO₂ gases and, optionally, CO₂ gas, wherein the beverage has between 0.01 and 1 standard volume of the one or more non-CO₂ gases dissolved per volume of liquid.

2. The effervescent packaged beverage of claim 1, wherein the beverage has between 0.05 and 0.3 standard volume of the one or more non-CO₂ gases dissolved per volume of liquid

3. The effervescent packaged beverage of claim 1, comprising one or more non-CO₂ gases and CO₂ gas, wherein the beverage has less than 4.0 standard volume of CO₂ dissolved per volume of liquid.

4. The effervescent packaged beverage of claim 3, wherein the beverage has greater than 0.5 standard volume of CO₂ dissolved per volume of liquid.

5. The effervescent packaged beverage of claim 1, comprising one or more non-CO₂ gases and CO₂ gas, wherein the beverage has less than 2.0 and greater than 0.6 standard volume of CO₂ dissolved per volume of liquid.

6. The effervescent packaged beverage of claim 1, comprising one or more non-CO₂ gases and CO₂ gas, wherein the beverage has less than 1.8 and greater than 0.6 standard volume of CO₂ dissolved per volume of liquid. The effervescent packaged beverage of claim 1, wherein the beverage is beer.

8. The effervescent packaged beverage of claim 1, wherein the one or more non-CO₂ gas comprises at least one non-CO₂ gas selected from the group consisting of Ar, Kr, Xe, and SF₆.

9. The effervescent packaged beverage of claim 1, wherein the effervescent packaged beverage is packaged in container selected from the group consisting of bottle and cans.

10. The effervescent packaged beverage of claim 1, comprising one or more non-CO₂ gases and CO₂ gas, wherein the one or more non-CO₂ gas is Kr.

11. The effervescent packaged beverage of claim 1, comprising one or more non-CO₂ gases and CO₂ gas, wherein the one or more non-CO₂ gas is a mixture of Ar and Kr.

12. The effervescent packaged beverage of claim 9, wherein the container has a headspace comprising at least one selected from the group consisting of CO₂, nitrogen, N₂O, and non-CO₂ gases.

13. The effervescent packaged beverage of claim 12, wherein the container has a headspace pressure between 0.5 to 4 bar at room temperature.

14. The effervescent packaged beverage of claim 9, wherein the container does not contain a widget that introduces one or more gases into the beverage.

15. The effervescent packaged beverage of claim 1, wherein the beverage is pasteurized.

16. A method of introducing one or more gases into a liquid comprising:
a) introducing a feed liquid into at least one vessel,
b) injecting one or more non-CO₂ gases and, optionally, CO₂ gas into the feed liquid in the at least one vessel to obtain an effervescent liquid,
c) filling one or more containers with the effervescent liquid, and
d) sealing the one or more containers to obtain one or more packaged beverages,
wherein the one or more packaged beverages has less than 4.0 standard volume of CO₂ dissolved per volume of liquid, and
wherein the one or more packaged beverages has between 0.01 and 1 standard volume of one or more non-CO₂ gases dissolved per volume of liquid.

17. A system for producing a package beverage comprising:
at least one vessel comprising at least one input stream and at least one output stream, and
a packaging unit comprising at least one input stream that is fluidly connected to at least one output stream of the at least one vessel.
